(19) United States
(12) Patent Application Publication
(10) Pub. No.: US 2022/0012585 A1
(43) Pub. Date: Jan. 13, 2022

(54) DEEP REINFORCEMENT LEARNING WITH SHORT-TERM ADJUSTMENTS

(71) Applicant: Hitachi, Ltd., Tokyo (JP)

(72) Inventors: Hamed KHORASGANI, San Jose, CA (US); Chi ZHANG, San Jose, CA (US); Susumu SERITA, Sunnyvale, CA (US); Chetan GUPTA, San Mateo, CA (US)

(21) Appl. No.: 16/925,538

(22) Filed: Jul. 10, 2020

(51) Int. Cl. G06N 3/08; G06N 3/04

(52) U.S. Cl. CPC G06N 3/08; G06N 3/0454; G06N 3/0445

(57) ABSTRACT

Example implementations described herein involve a new reinforcement learning algorithm to address short-term goals. In the training step, the proposed solution learns the system dynamic model (short-term prediction) in a linear format in terms of actions. It also learns the expected rewards (long-term prediction) in a linear format in terms of actions. In the application step, the proposed solution uses the learned models plus simple optimization algorithms to find actions that satisfy both short-term goals and long-term goals. Through the example implementations, there is no need to design sensitive reward functions for achieving short-term and long-term goals concurrently. Further, there is better performance in achieving short-term and long-term goals compared to the traditional reward modification methods, and it is possible to modify the short-term goals without time-consuming retraining.

### BACKGROUND

### Field

The present disclosure is generally directed to reinforcement learning, and more specifically, to systems and methods involving deep reinforcement learning with short-term adjustments.

### Related Art

Traditionally, control solutions such as Model Predictive Control (MPC) have been applied to many industrial applications such as pressure control and temperature control in chemical processes. In the related art, deep reinforcement learning (RL) has shown promising results in solving some complex problems. For example, it has generated superhuman performance in chess and shogi. The following advantages make deep RL a strong candidate for solving complex problems. First, deep RL can solve problems even when the consequences of an action are not immediately obvious. Secondly, it can learn an optimal solution without requiring detailed knowledge of the systems or their engineering designs. Finally, deep RL is not limited to time-series sensors and can use new sensors such as vision for better control.

However, deep RL has not been applied to address industrial problems in a meaningful way. There are several key issues that limit the application of deep RL to real-world problems. Deep RL algorithms typically require many samples during training (sample complexity). Sample complexity leads to high computational costs as 1) the simulators have to generate many scenarios and 2) the neural networks have to be trained over many batches of data to learn the RL policy. A high computational cost can be justified for industries as a one-time charge. However, oftentimes small changes in the system goal, such as changing the desired temperature in a chemical reactor, or a new constraint such as a maximum allowable temperature in the reactor, require retraining the model. Moreover, industrial systems often have several simultaneous short-term and long-term objectives.

### SUMMARY

Consider the crane system illustrated in FIG. 1. The long-term goal is to convey the payload to the target location as soon as possible. However, when the payload gets close to the target, it must have minimum sway for the safety of the operators. There is no analytical approach to modify the reward function in order to address short-term goals. Therefore, designing a reward function for deep RL that can capture both short-term and long-term goals can be challenging or even infeasible.

In example implementations described herein, there is a new deep RL solution that 1) can achieve short-term and long-term goals concurrently without modifying the reward function. The approach described herein shows better performance in achieving short-term and long-term goals compared to the traditional reward modification methods. 2) it is possible to modify the short-term goals without time-consuming retraining. This addresses the problem of sample complexity in the scenarios where small changes in the short-term goals are frequent.

In Reinforcement Learning (RL) algorithms, an agent in state x takes action u and receives reward r form environment, E. RL learns a policy, Π(u|x), that generates a set of actions, u, that maximize the expected sum of rewards in the environment. The reward functions typically capture the agent's long-term goals. When there are short-term goals (such as avoiding obstacles or driving with a given speed in a certain area) in addition to the long-term goal (such as reaching to the destination), reward modification (designing a reward function that captures both short-term and long-term goals) can be used.

However, reward modification approaches have several challenges. For example, there is no analytical method for modifying a reward function to achieve both short-term and long-term goals. When the short-term goals change, the model needs to be retrained, and model training is time consuming and expensive. Further, reward modification methods often do not perform well in satisfying short-term goals. Therefore, many industries do not use RL for problems with short-term goals specially when the short-term goals change frequently.

In example implementations described herein, there are two types of short-term goals. One type is the short-term trajectory, such as to follow a specific speed or path for a period of time. Another type is the short-term constraint, such as to avoid obstacle or danger areas.

The example implementations described herein involve new reinforcement learning algorithm as follows to address short-term goals. In the training step, the example implementations learn the system dynamic model (short-term prediction) in a linear format in terms of actions. In the training step, the example implementations also learn the advantage function, A, in a linear format in terms of actions. The value function, V, represents the maximum cumulative rewards that can be achieved from the current state. The advantage function represents the maximum additional cumulative rewards we can achieve by taking action u. In the application step, example implementations use the learned models plus simple optimization algorithms to find actions, uₖ, that satisfy both short-term goals and long-term goals.

Through the example implementations described herein, there is no need to design sensitive reward functions for achieving short-term and long-term goals concurrently. Further, the example implementations provide better performance in achieving short-term and long-term goals compared to the traditional reward modification methods. Additionally, it is possible to modify the short-term goals without time-consuming retraining.

Aspects of the present disclosure can involve a method for determining actions through reinforcement learning with a short-term network and a long-term network, the method involving learning the short-term network, the short-term network configured to generate a first model in a linear structure with respect to the actions; learning the long-term network through reinforcement learning, the long term network configured to generate a second model with linear structure with respect to the actions; and utilizing the first model and the second model to determine the actions that achieve constraints defined for the first model and goals defined in the second model.

Aspects of the present disclosure involve a non-transitory computer readable medium, storing instructions for determining actions through reinforcement learning with a short-term network and a long-term network, the instructions involving learning the short-term network, the short-term network configured to generate a first model in a linear structure with respect to the actions; learning the long-term network through reinforcement learning, the long term network configured to generate a second model with linear structure with respect to the actions; and utilizing the first model and the second model to determine the actions that achieve constraints defined for the first model and goals defined in the second model.

Aspects of the present disclosure can involve a system for determining actions through reinforcement learning with a short-term network and a long-term network, the system involving means for learning the short-term network, the short-term network configured to generate a first model in a linear structure with respect to the actions; means for learning the long-term network through reinforcement learning, the long term network configured to generate a second model with linear structure with respect to the actions; and means for utilizing the first model and the second model to determine the actions that achieve constraints defined for the first model and goals defined in the second model.

Aspects of the present disclosure can involve an apparatus configured for determining actions through reinforcement learning with a short-term network and a long-term network, the apparatus involving a processor, configured to learn the short-term network, the short-term network configured to generate a first model in a linear structure with respect to the actions; learn the long-term network through reinforcement learning, the long term network configured to generate a second model with linear structure with respect to the actions; and utilize the first model and the second model to determine the actions that achieve constraints defined for the first model and goals defined in the second model.

### BRIEF DESCRIPTION OF DRAWINGS

FIG. 1 illustrates an example crane system.

FIG. 2 illustrates an example structure to learn the parameters of the short-term and long-term prediction models, in accordance with an example implementation.

FIG. 3 illustrates an example flow for locally linear Q-Learning Training, in accordance with an example implementation.

FIG. 4 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The goal of RL is to learn a policy, Π(u|x), that generates a set of actions, u, that maximize the expected sum of discounted rewards R=Σγ×r in the environment, En. γ<1 represents the discount factor which gives higher weights to the immediate rewards. Unlike control algorithms, model-free reinforcement learning algorithms assume the system dynamic is unknown. Q-learning algorithms are among the most common model-free RL methods. Q-function, Q^{Π}(xₖ,uₖ) is defined as the expected return at state xₖ when we take action uₖ and adopt policy H afterward. Deep Q learning algorithms, use deep learning to learn the Q-function and select an action which maximizes Q-value at each step.

In discrete action environments the agent can take limited number of actions in each step (e.g., move up, down, right, or left). In these environments, after learning the Q-function, it is possible to check all the possible actions and select the action which maximizes the Q-function. For continuous action domain problems (for example, move 10.5 yards toward in 38 degree), there are infinite choices and therefore, it is impractical to check all the possible actions to find the action which maximizes Q-value at each step. Finding an action to maximize Q which can be a complex nonlinear function is computationally expensive or even infeasible. To address this problem, there is the Deep Deterministic Policy Gradient (DDPG) algorithm, which learns two networks simultaneously. The critic network learns Q-function, and the actor network learns parameters of the policy that maximizes the estimated value of Q-function. Further, there is Normalized Advantage Function (NAF) Q-learning which formulates the Q-function as the sum of the value function, V (x), and the advantage function, A(x, u).

Q(x,u|θ^{Q})=V(x|θ^{V})+A(x,u|θ^{A}) (1)

Value function, V, is only a function of current state and models the value of current state. Therefore, selecting different actions does not change the value function. Advantage function, A, represents the advantage we can achieve by taking action u. The advantage function can be modeled as a negative quadratic function in terms of u. This simple trick makes finding u which maximizes A trivial as then the only requirement is to find an action which makes the quadratic function A=0.

Mathematically speaking, there is:

A(x,u)=−½(u−μ(x))^{T}P(x)(u−μ(x)) (2)

Where P(x) is a positive-definite matrix, and therefore, the action that maximizes the advantage function and the Q-function is given by u=p(x).

### Locally Linear Q-Learning

Deep Q-learning with continuous action have huge potentials to solve many industrial challenges such as automated robotic arms for assembly lines, or crane navigation control system. However, the Deep Q-learning solutions required complex reward designed to address short-term constrains and trajectories. Moreover, there is a need to retrain the model anytime the short-term goals are modified, which is expensive and time-consuming. In the following, the example implementations involve a new Q-learning based solution which can be adjusted during the application (without retraining) to achieve short-term goals while delivering the original long-term goal. This solution is referred to herein as the Locally Linear Q-Learning (LLQL). The LLQL is designed to work in a continuous action space. The approach as described herein learns short-term and long-term prediction models. By using these models, a controller generates actions that guide the system toward its short-term and long-term goals.

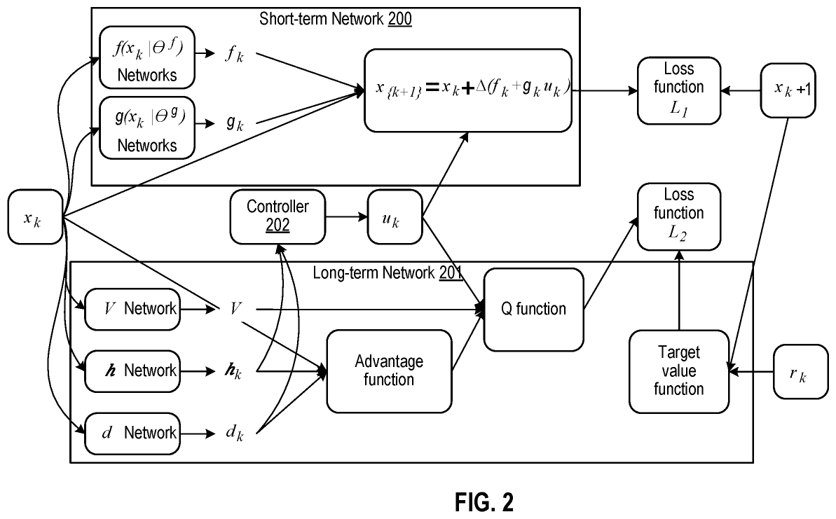

FIG. 2 illustrates an example structure to learn the parameters of the short-term and long-term prediction models, in accordance with an example implementation.

For short-term prediction 200, example implementations utilize the following locally linear structure to model system short-term behavior:

xₖ₊₁=xₖ+Δ(f(xₖ)+9(xₖ)uₖ) (3)

Where xₖ is the system current state, xₖ₊₁ represents the system state in the next step, Δ is the sampling rate and f(xₖ) and g(xₖ) represent system dynamic which show the relationship between current state, the action, uₖ, and the next state. In equation (3), the example implementations model the system dynamic as a locally linear model with respect to actions, uₖ. In other words, at each state, xₖ, there is a linear model with respect to actions represented by f(xₖ) and g(xₖ) that can be used to predict the next state, xₖ₊₁.

Example implementations involve deep neural networks to estimate system dynamic functions, f(xₖ) and g(xₖ) as a function of state xₖ at each operating point. Substituting the network estimations for these functions in (3), the next state can be predicted as:

\hat{x}ₖ₊₁=xₖ+Δ(f(xₖ|θ^{f})+g(xₖ|θ^{g})uₖ) (4)

where \hat{x}ₖ₊₁ represents our estimation of the next step, and θ^{f} and θ^{g} are our neural network parameters. A is a constant hyper parameter. In dynamic systems, the difference between two consecutive states, xₖ, and xₖ, is typically very small. This difference is presented by Δ(f(xₖ|θ^{f})+g(xₖ|θ^{g})uₖ) in equation (4). Considering a small A leads to reasonable f(xₖ|θ^{f}) and g(xₖ|θ^{g}) values and, therefore, improves learning time and accuracy.

This dynamic system model is referred to as the short-term prediction model 200. The controller 202 uses this model to generate actions, which lead the system toward its short-term goals. In the example implementations described herein, it can be shown that the short-term prediction model 200 can be used to design actions to achieve short-term goals. To learn the parameters of our short-term prediction model, parameters θ^{f} and θ^{g} are learned which minimize the short-term prediction error, L1=∥xₖ₊₁−\hat{x}ₖ₊₁∥.

For long-term prediction 201, the Q-function represents the maximum cumulative reward that can be achieved from current state, xₖ, taking an action uₖ. Therefore, by learning Q-function, example implementations learn the long-term prediction model for the system. The Q-function is a sum of the value function and the advantage function. However, the advantage function A(x, u) can be presented using a locally linear function with respect to actions, uₖ, as

A(xₖ,uₖ|θ^{A})=−∥h(xₖ|θ^{h})+d(xₖ|θ^{d})uₖ∥² (5)

where h(xₖ|θ^{h}) and d(xₖ|θ^{d}) networks model the locally linear advantage function. Note the NAF advantage function is a special case of the LLQL advantage function when d(xₖ|θ^{d})=I, where I represents the identity matrix. To maximize Q-function, uₖ is designed to minimize the advantage function. Since we have modeled the advantage function as a locally linear function with respect to actions, it is straightforward to find uₖ that generates A=0 as follows.

Minimizing the advantage function in LLQL: For simplicity, let h(xₖ|θ^{h}), and d(xₖ|θ^{d}) be represented with hₖ and dₖ respectively in the remainder of the present disclosure. To maximize Q-function and achieve the long-term goal, a pseudo-inverse matrix multiplication is used, and thus a solution with the least squares error is derived as:

uₖ=−(dₖ^{T}dₖ)^{T}dₖ^{T}hₖ. (6)

When ∥dₖ∥=0, it means the network predicts that the action has no impact on the advantage function. Therefore, a random action is chosen. Random exploration is an important part of any deep RL algorithm. Therefore, in addition to this unlikely case, noise, Nₖ, is added to the action, uₖ, during the training. Reduce the amount of noise injected to the action as the network converges.

The details to train short-term and long-term models are presented further below. Learning the Q-function in the locally linear format enables the controller to solve uₖ with additional constraints to achieve the desired short-term trajectories. The short-term adjustment algorithms are described below herein.

Control strategy: by separating action design from prediction models, LLQL gives us the freedom to design different control strategies for achieving short-term and long-term goals. Moreover, the linear structure of short-term and long-term models simplifies the control design. Consider the case where LLQL has learned a perfect long-term model for an environment. In this case, the optimum solution to achieve the long-term goal as was shown in equation (6) is given by uₖ=−(dₖ^{T}dₖ)^{T}dₖ^{T}hₖ. When there are one or more short-term goals as well, the control design can be formulated as an optimization problem to satisfy both short-term and long-term goals as much as possible.

In example implementations, there are two types of short-term goals: 1) desired trajectory, and 2) constraint. In the first scenario, the agent has a short-term desired trajectory. For example, a car may be required to travel with specific speed (say speed as close as possible to 30 mile/hr) during certain periods. In the second scenario, the agent has some limitation for a specific period of time. For example, a car is required to keep its speed below certain thresholds at some periods during the trip (say less than 60 mile/hr). To address the first problem, we add an additional term to the cost function for the short-term goal and solve for the action. We deal with the second problem as a constraint optimization.

Short-term trajectory: let x_{d} represent the desired short-term trajectory. Example implementations develop a control strategy to track x_{d} while pursuing the long-term goals. Define the control problem as an optimization problem which minimizes the advantage function |A(xₖ, uₖ)| to achieve the long-term goal and minimizes the short-term error between the desired trajectory at next time step, x_{d}(k+1), and real trajectory in the next step xₖ₊₁ which can be predicted using the short-term prediction model. The solution is the answer to the following optimization problem:

min(γ₁|A(xₖ,uₖ)|+γ₂|xₖ₊₁−x_{d}(k+1))|) (7)

γ₁ and γ₂ determine the importance of the short-term trajectory compared to the long-term trajectory. Higher

$$\frac{{γ}_{2}}{{γ}_{1}}$$

means we give higher weight to the short-term goal. Since the advantage function is learned in a linear format, a solution to find uₖ in each time step can be developed. The mathematical solution for equation (7) is presented below (see equation (10)). This solution only requires couple of matrix operation, and therefore is very fast. Having the solution in equation (10), apply the following hybrid approach to achieve both short-term and long-term goals:

$${u}_{k} = \{ \begin{matrix}use equation ( 6 ) when there is no short \text{-} term requrement . \\ use equation ( 10 ) when there is a short \text{-} term requrement .\end{matrix}$$

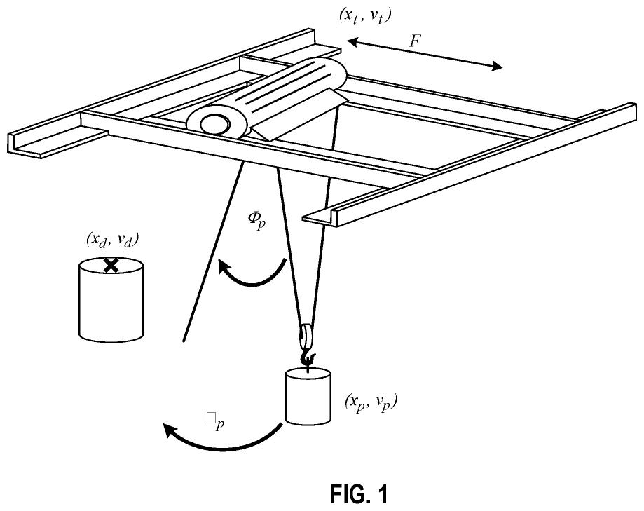

As an example, consider the gantry cranes shown in FIG. 1. These systems are widely used in industrial production lines and construction projects for transferring heavy and hazardous materials. The objective of the crane system is to convey the payload from the start position to the destination position as soon as possible while keeping the payload sway at the destination minimum. Higher traveling speed improves the efficiency and reduces costs. However, excessive movements at the destination wastes time and energy and can lead to accidents. To move the payload as fast as possible and stop the sway at the destination, skillful operators are required. Labor shortage in industries, and risk of human error, have motivated us to apply an automated solution for crane control. The crane dynamic system is highly nonlinear. Traditional nonlinear control techniques such as sliding control and adaptive control have been applied to these systems. These methods require detailed mathematical model of the system and its environment, which can be complicated and expensive to derive. When a simulator is available for a crane system, RL algorithms can provide a compelling alternative to traditional control methodologies. This is the case in many industries, where the simulators can be purchased but the detailed models are not shared with the costumers.

For example, a crane simulator provides us six state variables: 1) trolley location, x_{trolley} 2) trolley velocity, v_{trolley}, 3) payload angle, θ_{payload}, 4) payload angular velocity, ω_{payload}, 5) payload horizontal location, x_{payload}, and 6) payload vertical location, y_{payload}. The only action is the force applied to the trolley, u_{trolley}. The overall goal is to reach the final destination x_{pd} and y_{pd} in the shortest time possible (see FIG. 1). By choosing a simple reward function, the LLQL can be trained to reach this long-term goal. In additional to the long-term goal, the short-term goal is to minimize the object's sway when it reaches to the final destination. Instead of designing complicated reward functions to achieve minimum travel time and minimum sway, consider ω_{payload}=0 at the final destination as our short-term desired trajectory and applied our control strategy to achieve this goal as follows.

$${u}_{k} = \{ \begin{matrix}use equation ( 10 ) when the trolley is close to the final destination . \\ use equation ( 6 ) otherwise .\end{matrix}$$

The results showed the crane system can achieve both long-term and short-term goals without complicated reward functions.

Short-term constraint: the LLQL algorithm provides a framework to design the actions considering different constraints as well. For safe operation, the agent may have to avoid specific states for a period of time (for example, high speed or locations close to an obstacle). For simplicity, assume at each moment we only have maximum one constraint on one state variable, xⁱ. This is a reasonable assumption, because in physical systems the agent is close to one of the boundaries at any moment in time. When this is not the case, then new constraints can be defined as a combination of constraints. Consider cₖⁱ as the constraint on the state variable, xⁱ, at time k. Define the constraint optimization problem for LLQL as

min∥A(xₖ,uₖ)∥²

such that xₖ₊₁ⁱ<cₖ₊₁ⁱ (8)

Since the advantage function, A, is learned in a linear format, a solution to find u_k can be developed in each time step that satisfies our constraint while moving toward the long-term goal. The mathematical details of addressing short-term constraint is presented below (see equation (13)).

Similar to the solution for the short-term trajectories, the solution for short-term constraint only requires couple of matrix operation, and therefore is computationally efficient. Having the solution in equation (13) (see the appendix), apply the following hybrid approach to achieve the long-term goals while not violating the short-term constraint:

$${u}_{k} = \{ \begin{matrix}use equation ( 13 ) when we are close to the constraints . \\ use equation ( 6 ) otherwise .\end{matrix}$$

### Training Deep Learning Models to Learn the Short-Term and Long-Term Models

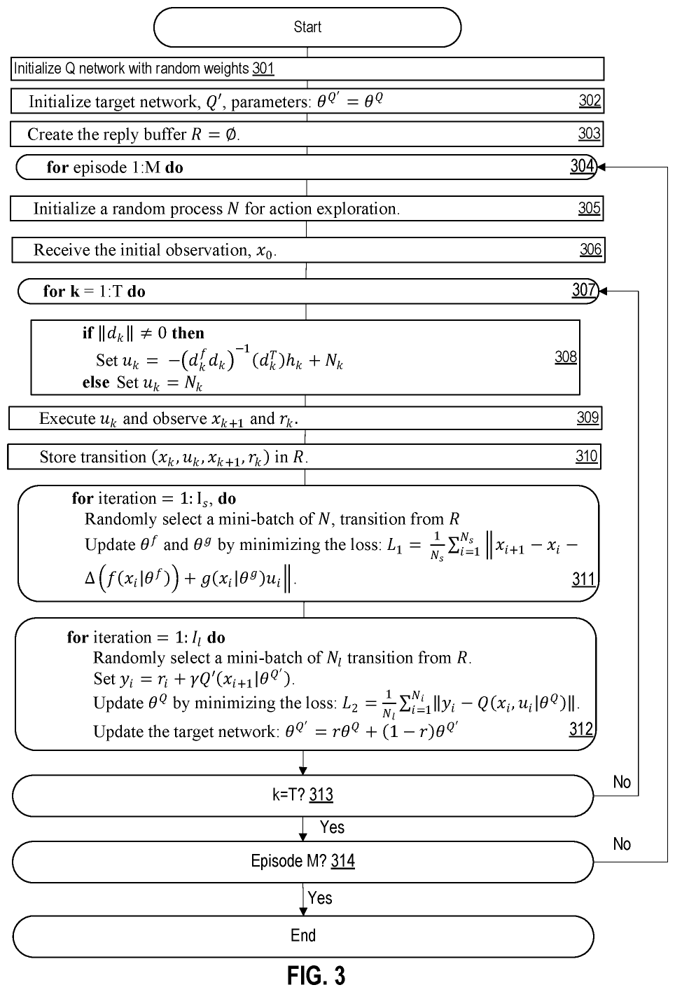

The detailed strategy to learn short-term and long-term models is presented herein using neural networks. FIG. 3 illustrates an example flow for locally linear Q-Learning Training, in accordance with an example implementation. As it is shown in FIG. 3, the neural networks are trained by minimizing the short-term loss function L₁ and the long-term loss function L₂ for each batch of samples.

At 301, the algorithm initializes the Q network with random weights. At 302, the algorithm initializes the target network, Q′, and parameters: θ^{Q}′=θ^{Q}. At 303, the algorithm creates the reply buffer R=Ø.

At 304, a loop is initialized for each episode from 1 to M. The loop involves the following processes.

At 305, the algorithm initializes a random process N for action exploration. At 306 the algorithm receives the initial observation, x₀.

At 307, an interior loop is initialized for k=1:T, which involves the following processes. At 308, a determination is made as to whether ∥dₖ∥≠0. If so, then the algorithm sets uₖ=−(dₖ^{f}dₖ)⁻¹(dₖ^{T})hₖ+Nₖ, otherwise the algorithm sets uₖ=Nₖ. At 309, the algorithm executes uₖ and observe xₖ₊₁ and rₖ. At 310, the algorithm stores the transition (xₖ,uₖ,xₖ₊₁,rₖ) in R.

At 311, another interior loop within the k loop is conducted for iteration=1:Iₛ. Within this interior loop, the algorithm randomly selects a mini-batch of N, transition from R, updates θ^{f} and θ^{g} by minimizing the loss:

$${L}_{1} = \frac{1}{{N}_{s}} {\sum }_{i = 1}^{{N}_{s}} ‖ {x}_{i + 1} - {x}_{i} - Δ ( f ( {x}_{i} \vert {θ}^{f} ) ) + g ( {x}_{i} \vert {θ}^{g} ) {u}_{i} ‖ .$$

At 312, after the completion of the interior loop of 311, another interior loop within the k loop is conducted iteration=1:Iₗ. Within this interior loop, the algorithm randomly selects a mini-batch of Nₗ transition from R, sets yᵢ=rᵢ+γQ′(xᵢ₊₁|θ^{Q}′), updates θ^{Q} by minimizing the loss:

$${L}_{2} = \frac{1}{{N}_{l}} {\sum }_{i = 1}^{{N}_{i}} ‖ {y}_{i} - Q ( {x}_{i} , {u}_{i} \vert {θ}^{Q} ) ‖ ,$$

and updates the target network: θ^{Q}′=rθ^{Q}+(1−r)θ^{Q}′.

At 313, a determination is made as to whether the interior k loop has completed (k=T). If so (Yes), then the algorithm proceeds to 314, otherwise (No) the algorithm proceeds to 307 for the next iteration k. At 314, a determination is made as to whether the overall episode loop has completed. If so (Yes), then the algorithm ends, otherwise (No), the loop is reiterated with the next episode at 304.

### Detailed Mathematical Solution for the Short-Term Trajectory Problem

To solve equation(7), first rewrite it in the locally linear format:

min(γ₁(h(xₖ|θ^{h})+d(xₖ|θ^{d})uₖ)²+γ₂(xₖ₊₁−x_{d}(k+1)))²) (9)

Then, apply a simple pseudo-inverse matrix multiplication, and derive a solution with the least squares error for (9) as:

$${u}_{k}^{*} = {{( {[ \begin{matrix}{γ}_{1} {d}_{k} \\ - {γ}_{2} Δ {g}_{k}\end{matrix} ]}^{T} [ \begin{matrix}{γ}_{1} {d}_{k} \\ - {γ}_{2} Δ {g}_{k}\end{matrix} ] )}^{- 1} [ \begin{matrix}{γ}_{1} {d}_{k} \\ - {γ}_{2} Δ {g}_{k}\end{matrix} ]}^{T} [ \begin{matrix}- {γ}_{1} {h}_{k} \\ {γ}_{2} ( - {x}_{d ( k + 1 )} + {x}_{k} + Δ {f}_{k} )\end{matrix} ] \qquad ( 10 )$$

### Detailed Mathematical Solution for Short-Term Constraint Problem

To solve equation (8) rewrite it in the locally linear format:

min½(h(xₖ|θ^{h})+d(xₖ|θ^{d})uₖ)²

such that xₖ₊₁ⁱ<cₖ₊₁ⁱ (11)

The term ½ is a coefficient added to simplify the mathematical operation. Using the estimation of the next step:

xₖ₊₁ⁱ=xₖⁱ+(fₖⁱ+gₖⁱuₖ) (12)

the optimum action which satisfies the constraint can be derived using the Lagrangianas method as:

$${u}_{k}^{*} = - {( {d}_{k}^{T} {d}_{k} )}^{- 1} {d}_{k}^{T} ( {h}_{k} + {λ}^{*} {α}_{1} ) \\ where {α}_{1} = Δ {g}_{k}^{i} {{d}^{T} ( {d}_{k} {d}_{k}^{T} )}^{- 1} , {α}_{2} = Δ {{g}_{k}^{i} ( {d}_{k}^{T} {d}_{k} )}^{- 1} , {d}_{k}^{T} and {λ}^{*} = \frac{{x}_{k}^{i} + Δ {f}_{k}^{i} - {c}_{k + 1} - {α}_{2} {h}_{k}}{{α}_{1} {α}_{2}} . \qquad ( 13 )$$

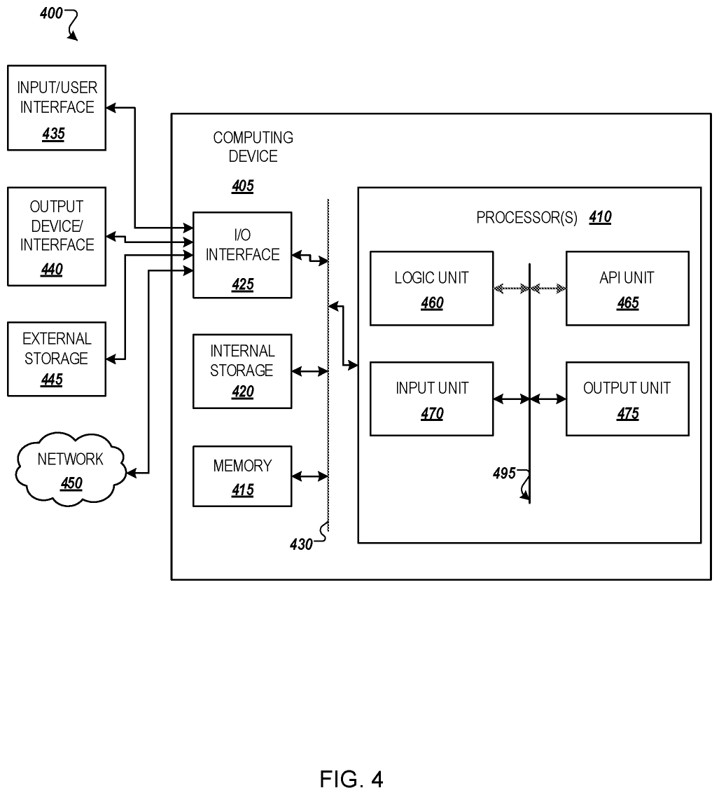

FIG. 4 illustrates an example computing environment with an example computer device suitable for use in some example implementations. Computer device 405 in computing environment 400 can include one or more processing units, cores, or processors 410, memory 415 (e.g., RAM, ROM, and/or the like), internal storage 420 (e.g., magnetic, optical, solid state storage, and/or organic), and/or IO interface 425, any of which can be coupled on a communication mechanism or bus 430 for communicating information or embedded in the computer device 405. IO interface 425 is also configured to receive images from cameras or provide images to projectors or displays, depending on the desired implementation.

Computer device 405 can be communicatively coupled to input/user interface 435 and output device/interface 440. Either one or both of input/user interface 435 and output device/interface 440 can be a wired or wireless interface and can be detachable. Input/user interface 435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 440 may include a display, television, monitor, printer, speaker, braille, or the like. In some example implementations, input/user interface 435 and output device/interface 440 can be embedded with or physically coupled to the computer device 405. In other example implementations, other computer devices may function as or provide the functions of input/user interface 435 and output device/interface 440 for a computer device 405.

Examples of computer device 405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 405 can be communicatively coupled (e.g., via IO interface 425) to external storage 445 and network 450 for communicating with any number of networked components, devices, and systems, including one or more computer devices of the same or different configuration. Computer device 405 or any connected computer device can be functioning as, providing services of, or referred to as a server, client, thin server, general machine, special-purpose machine, or another label.

IO interface 425 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 400. Network 450 can be any network or combination of networks (e.g., the Internet, local area network, wide area network, a telephonic network, a cellular network, satellite network, and the like).

Computer device 405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 410 can execute under any operating system (OS) (not shown), in a native or virtual environment. One or more applications can be deployed that include logic unit 460, application programming interface (API) unit 465, input unit 470, output unit 475, and inter-unit communication mechanism 495 for the different units to communicate with each other, with the OS, and with other applications (not shown). The described units and elements can be varied in design, function, configuration, or implementation and are not limited to the descriptions provided. Processor(s) 410 can be in the form of hardware processors such as central processing units (CPUs) or in a combination of hardware and software units.

In some example implementations, when information or an execution instruction is received by API unit 465, it may be communicated to one or more other units (e.g., logic unit 460, input unit 470, output unit 475). In some instances, logic unit 460 may be configured to control the information flow among the units and direct the services provided by API unit 465, input unit 470, output unit 475, in some example implementations described above. For example, the flow of one or more processes or implementations may be controlled by logic unit 460 alone or in conjunction with API unit 465. The input unit 470 may be configured to obtain input for the calculations described in the example implementations, and the output unit 475 may be configured to provide output based on the calculations described in example implementations.

Processor(s) 410 can be configured for determining actions through reinforcement learning with a short-term network and a long-term network as illustrated in FIG. 2. As illustrated in FIG. 2 and FIG. 3, processor(s) 410 can be configured to learn the short-term network, the short-term network configured to generate a first model in a linear structure from the actions; learn the long-term network through reinforcement learning, the long term network configured to generate a second model from the linear structure from the input; and utilize the first model and the second model to determine the actions that achieve constraints defined for the first model and goals defined in the second model. As described herein, the constraints defined for the first model can involve one or more of a trajectory or short term constraints.

As described herein, processor(s) 410 can be configured to learn the long term network through reinforcement learning by learning an advantage function in a linear format, the advantage function configured to indicate a maximum additional cumulative rewards achievable for each of the actions. As further described herein, the first model is a system dynamic model configured to provide a next state given an action and a current state.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for determining actions through reinforcement learning with a short-term network and a long-term network, the method comprising:
learning the short-term network, the short-term network configured to generate a first model in a linear structure with respect to the actions;
learning the long-term network through reinforcement learning, the long term network configured to generate a second model with linear structure with respect to the actions; and
utilizing the first model and the second model to determine the actions that achieve constraints defined for the first model and goals defined in the second model.

2. The method of claim 1, wherein the constraints defined for the first model comprise one or more of a trajectory or short term constraints.

3. The method of claim 1, wherein the learning the long term network through reinforcement learning comprises learning an advantage function in a linear format with respect to the actions, the advantage function configured to indicate a maximum additional cumulative rewards achievable for each of the actions.

4. The method of claim 1, wherein the first model is a system dynamic model configured to provide a next state given an action and a current state.

5. A non-transitory computer readable medium, storing instructions for determining actions through reinforcement learning with a short-term network and a long-term network, the instructions comprising:
learning the short-term network, the short-term network configured to generate a first model in a linear structure with respect to the actions;
learning the long-term network through reinforcement learning, the long term network configured to generate a second model with linear structure with respect to the actions; and
utilizing the first model and the second model to determine the actions that achieve constraints defined for the first model and goals defined in the second model.

6. The non-transitory computer readable medium of claim 5, wherein the constraints defined for the first model comprise one or more of a trajectory or short term constraints.

7. The non-transitory computer readable medium of claim 5, wherein the learning the long term network through reinforcement learning comprises learning an advantage function in a linear format with respect to the actions, the advantage function configured to indicate a maximum additional cumulative rewards achievable for each of the actions.

8. The non-transitory computer readable medium of claim 5, wherein the first model is a system dynamic model configured to provide a next state given an action and a current state.

9. An apparatus configured for determining actions through reinforcement learning with a short-term network and a long-term network, the apparatus comprising:
a processor, configured to:
learn the short-term network, the short-term network configured to generate a first model in a linear structure with respect to the actions;
learn the long-term network through reinforcement learning, the long term network configured to generate a second model with linear structure with respect to the actions; and
utilize the first model and the second model to determine the actions that achieve constraints defined for the first model and goals defined in the second model.

10. The apparatus of claim 9, wherein the constraints defined for the first model comprise one or more of a trajectory or short term constraints.

11. The apparatus of claim 9, wherein the processor is configured to learn the long term network through reinforcement learning by learning an advantage function in a linear format with respect to the actions, the advantage function configured to indicate a maximum additional cumulative rewards achievable for each of the actions.

12. The apparatus of claim 9, wherein the first model is a system dynamic model configured to provide a next state given an action and a current state.
